(19) United States
(12) Patent Application Publication
(10) Pub. No.: US 2006/0255880 A1
(43) Pub. Date: Nov. 16, 2006

(54) RF amplifier

(76) Inventors: Hidefumi Suzaki, Shiga (JP); Motoyoshi Iwata, Osaka (JP)

Correspondence Address: MCDERMOTT WILL & EMERY LLP, 600 13TH STREET, N.W., WASHINGTON, DC, 20005-3096, US

(21) Appl. No.: 11/414,486

(22) Filed: May 1, 2006

(30) Foreign Application Priority Data
May 11, 2005 (JP) 2005-138871

(51) Int. Cl. H01P 1/10

(52) U.S. Cl. 333/104

(57) ABSTRACT

An RF amplifier includes a transistor for an RF signal amplification; and a diode which is connected at one of two terminals thereof to an input terminal of the transistor and receives the RF signal at the other terminal. This structure enables the RF amplifier to operate stably.

### CROSS-REFERENCE TO RELATED APPLICATION

This application claims priority under 35 USC §119 to Japanese Patent Application No. 2005-138871 filed on May 11, 2005, the entire contents of all of which are incorporated herein by reference.

### BACKGROUND OF THE INVENTION

The present invention relates to radio frequency (RF) amplifiers used for RF signal amplifications in a mobile terminal and a fixed terminal in a wireless communication system such as a cellular phone system.

Several RF amplifiers are placed in the mobile and fixed terminals in a wireless communication system in order to amplify RF signal.

These RF amplifiers are classified into power amplifiers, low noise amplifiers, variable gain amplifiers and driver amplifiers. Power amplifiers are used in the transmission circuit block and low noise amplifiers are used in the reception circuit block for RF signal amplifications. Variable gain amplifiers and driver amplifiers are used for general purpose RF signal amplifications in the RF signal processing circuit block including the transmission and reception circuit block.

In wireless communication systems such as cellular phone systems, quasi microwave band is used for the carrier frequency. High performance transistors are adopted for RF signal amplifications in this frequency band. The cut-off frequency of these transistors is from 20 GHz to 50 GHz and the operating state without the stabilization of these transistors is usually unstable condition over a wide frequency band including quasi microwave band. In particular, at the lower frequency band than quasi microwave band, the higher amplification performance of these transistors causes undesirable oscillation while these transistors are operating in a mobile terminal and a fixed terminal. These transistors should be carefully operated in stable condition over the entire frequency band including quasi microwave band.

FIG. 11 illustrates the circuit configuration of a conventional RF amplifier, more specifically, a conventional RF power amplifier (see the specifications of U.S. Pat. Nos. 5,608,353 and 5,629,648, for example). As shown in FIG. 11, the conventional RF power amplifier has a single stage structure in which n transistors 77 to 78 (n≧2) are connected in parallel. In FIG. 11, the transistor 77 is the first and the transistor 78 is the n-th. Capacitors 79 and 80 and resistors 81 and 82 are connected to the input terminals (bases) of the respective transistors 77 and 78. The other terminals of the respective capacitors 79 and 80 are connected to each other and then connected to a first input terminal 83, to which an RF signal is input. The other terminals of the respective resistors 81 and 82 are connected to each other and then connected to a second input terminal 84, to which DC base current for the appropriate collector operating current of the transistors 77 and 78 is supplied.

FIG. 12 illustrates an exemplary cross-sectional structure of a conventional diode formed on a semiconductor substrate. As shown in FIG. 12, a p-type doped layer 86 is formed on a semi-insulating layer 85, and an n-type doped layer 87 is selectively formed on the p-type doped layer 86. In a region on the p-type doped layer 86 other than the n-type doped layer 87 formation region, a first metal interconnect 88 is formed. On the n-type doped layer 87, a second metal interconnect 89 is formed. In this example, a PN junction is formed between the p-type doped layer 86 and the n-type doped layer 87, and thereby forming the diode in which the first metal interconnect 88 is the anode and the second metal interconnect 89 is the cathode. The first metal interconnect 88 and the second metal interconnect 89 are also used for the connections between other circuit elements such as resistors, capacitors and transistors. If these metal interconnects 88 and 89 are crossed, a third metal interconnect 91 formed in another interconnect layer are provided and are connected to the second metal interconnect 89 by a through hole 90.

FIG. 13 shows the plan configuration of an interconnect pattern in a diode according to a conventional example (see Japanese Laid-Open Publication No. 2706445). In FIG. 13, the same members as those shown in FIG. 12 are identified by the same reference numerals. As shown in FIG. 13, on the p-type doped layer 86 formed in the shape of a rectangle when viewed from above, the first metal interconnect 88, which serves as the anode, is formed in the shape of a comb when viewed from above. The n-type doped layer 87 is also formed in the shape of a comb so that its teeth are placed between the teeth of the comb-shaped first metal interconnect 88 with a spacing therebetween. On the n-type doped layer 87, the second metal interconnect 89 is formed in the shape of a comb so as to face the n-type doped layer 87. The second metal interconnect 89 is connected with the third metal interconnect 91 by the through hole 90.

FIG. 14 shows the plan configuration of another interconnect pattern in a diode according to a conventional example. As shown in FIG. 14, on a p-type doped layer 86 formed to have the shape of a rectangle when viewed from above, a first metal interconnect 88, which serves as the anode, is formed so as to be in contact with one side of the p-type doped layer 86. On the p-type doped layer 86, an n-type doped layer 87 is formed so as to cover almost the entire surface of the p-type doped layer 86 and so as to be spaced apart from the first metal interconnect 88. On the n-type doped layer 87, a second metal interconnect 89 is formed, which is connected with a third metal interconnect 91 by a through hole 90.

The miniaturization of RF amplifiers is strongly required for a mobile terminal such as a cellular phone. A monolithic microwave integrated circuit (MMIC) technology is adopted in order to meet the requirement. Using the MMIC technology, transistors, capacitors, inductors, resistors and the other components are integrated into a monolithic semiconductor substrate. As the capacitors, metal-insulator-metal (MIM) capacitors are used, in each of which a dielectric layer is interposed between two metal layers formed on the semiconductor substrate.

In a conventional MIM capacitor, the capacitance value per unit area is selected from 200 pF/mm² to 400 pF/mm². As shown in FIGS. 15A and 15B, in conventional RF amplifiers each including a transistor 92, a resistor to stabilize a transistor (a stabilizing resistor) 93 is provided at the input or output side. And a capacitor 94 is placed between the stabilizing resistor 93 and ground in order to isolate DC current and provide appropriate bias current to the transistor 92. The capacitance value of the capacitor 94 should be selected more than 50 pF in order to isolate DC current and bypass RF signal to ground at the lower frequency band. Using MIM capacitors are used for DC isolation and RF bypassing, the area occupied by the MIM capacitors on the semiconductor substrate is approximately 0.125 mm² to 0.25 mm². Considering that the total chip size of the conventional RF amplifier is approximately 1 mm² to 1.5 mm², the capacitor 94 using MIM capacitor for DC isolation and RF bypassing occupies the quite large area in the total semiconductor chip.

For the conventional RF power amplifier shown in FIG. 11, the stabilization of the transistors 77 and 78 is not mentioned. Generally, for RF signal amplifications, transistors with the enough amplification performance are selected. These transistors are higher amplification performance but causes undesirable oscillations without the sufficient and careful stabilization of these transistors. If these undesirable oscillations can not be controlled, these transistors can not be used for RF amplifiers.

Also, as shown in FIG. 11, RF power amplifier is generally composed of at least two transistors 77 and 78 in parallel for the amplification to the required RF signal power level. However, when RF amplifier is composed of the parallel-connected bipolar transistors, one of the transistors 77 and 78 could be partly heated up because of the deference of the each transistors thermal resistance, and unusually large amount of base current could flow into the heated transistor. This partly heated transistor causes a thermal runaway phenomenon including other transistors composing RF amplifier.

In order to prevent this phenomenon, the resistors 81 and 82 are connected to the each base terminal of the transistors 77 and 78. These resistors 81 and 82 can reduce unusually large amount of current and prevent the concentration of base current to the transistors 77 and 78. If the base terminals of transistors 77 and 78 are connected with each other in order to input RF signal, the base current will concentrate in one of transistors because of the deference of the intrinsic base resistances of the transistors 77 and 78. The capacitors 79 and 80 are provided to cut off DC current and allow the resistors 81 and 82 to operate effectively as ballast resistors for the transistors 77 and 78.

There is little attenuation of the RF signal by the resistors 81 and 82 because RF signal is input through the capacitors 79 and 80. It is therefore possible to select sufficiently high resistance value for the respective resistors 81 and 82 not to cause a thermal runaway of the transistors 77 and 78.

In the case of the RF power amplifier circuit configure shown in FIG. 11, the base terminals of the transistors 77 and 78 are terminated to OPEN termination at the lower frequency band because the input impedance of the capacitors 79 and 80 is too high at the lower frequency band including DC.

In the range of the conventional technique, a MIM capacitor can not realize higher capacitance value per unit area and hardly passes the RF signal. Using these MIM capacitors, stabilizing resistors placed between the input terminal 83 and the capacitors 79 and 80 could not operate to stabilize the transistors 77 and 78 effectively. It could be difficult to select the condition of the effective termination for stabilizing resistors 81 and 82 because the impedance terminated to transistors 77 and 78 are fixed the high impedance of the capacitors 79 and 80 at the lower frequency band.

Moreover, a sufficiently large area MIM capacitor is required in order to transmit RF signal to transistors 77 and 78 with minimum losses in the capacitors 79 and 80. The transmission characteristics of a capacitor depend on the RF signal frequency and are provided the difference transmission characteristics at the same capacitance value. At least capacitance value for 20 pF should be selected in order to transmit the RF signal of 1 GHz. Using a conventional MIM capacitor technology, the area of 20 pF capacitance value is estimated approximately 0.05 mm² to about 0.1 mm². Furthermore, when the capacitor is applied to an RF power amplifier or the like, this capacitance value of 20 pF must be divided by the number of transistor cells in the parallel-connected for RF signal amplification.

More specifically, in a case where 50 transistor cells for RF signal amplification are connected in parallel, 20 pF/50 cells=0.4 pF (which is the capacitance value of a capacitor connected to a single cell). These fifty capacitors must be isolated each other and need more space for the isolation on the semiconductor chip.

As in the conventional diode shown in FIG. 12, in the semiconductor substrate for the integration of RF amplifiers, the p-type doped layer 86 is thinned to the thickness of the range from 50 nm to 200 nm for the improvements of the high frequency amplification performance. On the p-type doped layer 86, the n-type doped layer 87 is formed, whereby the capacitance is formed by the PN junction between the p-type doped layer 86 and the n-type doped layer 87. This capacitance value also depends on the dopant concentration of the n-type doped layer 87, and the capacitance value per unit area is 3000 pF/mm², which is about ten times that of a MIM capacitor. However, since the thickness of the p-type doped layer 86 is extremely thin, the sheet resistance is as high as 100Ω to 400Ω. In the semiconductor substrate structure like this, even if the PN junction capacitance allows a large capacitance value to be obtained, the aforementioned higher sheet resistance value cause increase in the intrinsic series resistance of PN junction capacitance depending on the electrode-extending structure. A capacitor with high intrinsic series resistance is not suitable using for RF signal amplification.

Also, in the interconnect pattern in the conventional diode shown in FIG. 13, the first metal interconnect (cathode) 88 is provided in the shape of a comb for connection with the p-type doped layer 86 located under the n-type doped layer 87, and is connected with the p-type doped layer 86 on the semiconductor substrate. The capacitance value of the PN junction is proportional to the area of the n-type doped layer 87 placed below the cathode 88. Therefore, the method, in which the cathode 88 is provided in the shape of a comb when viewed from above for connection with the p-type doped layer 86 with the n-type doped layer 87 partially notched, reduces the usability of the area.

Moreover, in the other interconnect pattern in the conventional diode shown in FIG. 14, the plan shape of the n-type doped layer 87 is a rectangle similar to that of the p-type doped layer 86, which allows the area usability and hence the PN junction capacitance to be increased. Nevertheless, the first metal interconnect 88 serving as the anode is extended beyond one side of the p-type doped layer 86, causing the resistance value of the p-type doped layer 86 to increase. It is thus not practical to use this structure as a capacitor.

### SUMMARY OF THE INVENTION

It is therefore an object of the present invention to solve the above problems and prevent undesirable oscillation and thermal runaway of transistors for RF signal amplification in an RF amplifier so that their high-performance operation is kept in stable condition and size reduction is achieved in the RF amplifier.

In order to achieve the above object, an RF amplifier according to the present invention has a structure in which diodes are used instead of capacitors for the separation from DC current applied to next transistors and input RF signal for RF signal amplification.

More specifically, a first inventive RF amplifier includes: a transistor for RF signal amplification; and a diode which is connected at one of two terminals thereof to an input terminal of the transistor for RF signal amplification and receives the RF signal at the other terminal.

In the first inventive RF amplifier, intrinsic series resistance of the diode behaves as a stabilizing resistor, which enables the RF amplifier to operate under the stable condition. In addition, the capacitance value of a PN junction in the diode is sufficiently large. Therefore, when a plurality of inventive RF amplifiers is connected each other, the inventive RF amplifiers can transmit an RF signal through the capacitors formed by PN junction of the diodes. As a result, it is possible to cut off only DC current and to input the desired RF signal to the input terminal of the transistor for RF signal amplification.

A second inventive RF amplifier includes: a transistor for RF signal amplification; and a diode which is connected at one of two terminals thereof to an output terminal of the transistor for the RF signal amplification and outputs from the other terminal an amplified RF signal obtained by amplifying the RF signal.

In the second inventive RF amplifier, intrinsic series resistance of the diode behaves as a stabilizing resistor, which enables the RF amplifier to operate under the stable condition. Furthermore, since the stabilization can operate not at the input terminal but at the output terminal of a transistor for RF signal amplification, the transistor can provide good noise performance as well as a stable operation. This circuit configure is particularly suitable for use as a low-noise amplifier.

In addition, the capacitance value of a PN junction in the diode is sufficiently large. Therefore, when a plurality of inventive RF amplifiers is connected each other, the inventive RF amplifiers can transmit an RF signal through the capacitors formed by PN junction of the diodes. As a result, it is possible to cut off only DC current and to transmit the desired RF signal to the input terminal of the next amplification stage.

A third inventive RF amplifier includes: a transistor for RF signal amplification; and a diode which is connected at one of two terminals thereof to an input terminal of the transistor for the RF signal amplification and is grounded at the other terminal.

In the third inventive RF amplifier, intrinsic series resistance of the diode behaves as a stabilizing resistor, which enables the RF amplifier to operate under the stable condition. In addition, the PN junction capacitance in the diode is sufficiently large.

It is therefore possible to bypass part of an RF signal to ground via the series resistance of the diode (the stabilizing resistor) at the lower frequency. As a result, it is possible to realize an RF amplifier that operates under the stable condition over a wide frequency range including a frequency band in which RF signal are amplified.

A fourth inventive RF amplifier includes: a transistor for RF signal amplification; and a diode which is connected at one of two terminals thereof to an output terminal of the transistor for the RF signal amplification and is grounded at the other terminal.

In the fourth inventive RF amplifier, intrinsic series resistance of the diode behaves as a stabilizing resistor, which enables the RF amplifier to operate under the stable condition. Furthermore, since the stabilization can operate not at the input terminal but at the output terminal of a transistor for RF signal amplification, the transistor can provide good noise performance as well as a stable operation. This circuit configure is particularly suitable for use as a low-noise amplifier.

In addition, the PN junction capacitance in the diode is sufficiently large. It is therefore possible to bypass part of an RF signal to ground via the series resistance of the diode (the stabilizing resistor) at the lower frequency. As a result, it is possible to realize an RF amplifier that operates under the stable condition over a wide frequency range including a frequency band in which RF signal are amplified.

In the first to fourth inventive RF amplifiers, in the diode, a first doped layer of a first conductivity type and a second doped layer of a second conductivity type formed on the first doped layer preferably form a junction; a first electrode is preferably formed on the first doped layer and a second electrode is preferably formed on the second doped layer; and the first electrode is preferably not in contact with the second doped layer, and when the first doped layer has the shape of a polygon with n vertices when viewed from above (n≧3), the first electrode is preferably connected with the first doped layer in such a manner that the first electrode is in contact with at least two sides of the polygon, and when the first doped layer has the shape of a circle or an ellipse when viewed from above, the first electrode is preferably connected with the first doped layer in such a manner that the first electrode is in contact with more than 75% of the perimeter of the circle or the ellipse. Then, the contact resistance (series resistance) between the first electrode and the first doped layer is reduced.

In this case, the first electrode is preferably connected to the input terminal or the output terminal of the transistor; and a third electrode for applying a DC bias to the transistor is preferably formed on the first doped layer. Then, the resistance value required for stabilizing the first doped layer can be set at the desired value.

A fifth inventive RF amplifier includes: a plurality of transistors for RF signal amplification, which are connected in parallel with each other and each of which amplifies an RF signal; a plurality of diodes, each of which is connected at one of two terminals thereof to an input terminal of an associated one of the transistors for RF signal amplification and receives the RF signal at the other terminal; and a plurality of resistors, each of which is connected at one of two terminals thereof to the input terminal of an associated one of the transistors for RF signal amplification and receives a DC bias signal at the other terminal.

In the fifth inventive RF amplifier, the effects obtained by the first inventive RF amplifier are also achieved. In addition, the resistors connected to the respective transistors prevent concentration of current in one of the transistors for RF signal amplification caused by a failure, whereby a stable and highly reliable RF amplifier can be realized.

In the fifth inventive RF amplifier, in each of the diodes, a first doped layer of a first conductivity type and a second doped layer of a second conductivity type formed on the first doped layer preferably form a junction, a first electrode is preferably formed on the first doped layer and a second electrode is preferably formed on the second doped layer, and the first electrode is preferably not in contact with the second doped layer, and when the first doped layer has the shape of a polygon with n vertices when viewed from above (n≧3), the first electrode is preferably connected with the first doped layer in such a manner that the first electrode is in contact with at least two sides of the polygon, and when the first doped layer has the shape of a circle or an ellipse when viewed from above, the first electrode is preferably connected with the first doped layer in such a manner that the first electrode is in contact with more than 75% of the perimeter of the circle or the ellipse.

In this case, the first electrode is preferably connected to the input terminal of an associated one of the transistors; and a third electrode for applying a DC bias to the transistor is preferably formed on the first doped layer.

### BRIEF DESCRIPTION OF THE DRAWINGS

FIG. 1 is a circuit diagram illustrating an exemplary RF amplifier according to a first embodiment of the present invention.

FIG. 2 is a circuit diagram illustrating an exemplary RF amplifier according to a second embodiment of the present invention.

FIG. 3 is a circuit diagram illustrating an exemplary RF amplifier according to a third embodiment of the present invention.

FIG. 4 is a circuit diagram illustrating an exemplary RF amplifier according to a fourth embodiment of the present invention.

FIG. 5 is a circuit diagram illustrating an exemplary RF amplifier according to a fifth embodiment of the present invention.

FIG. 6 is a plan view illustrating a first diode for use in the RF amplifier according to the fifth embodiment of the present invention.

FIG. 7 is a plan view illustrating a second diode for use in the RF amplifier according to the fifth embodiment of the present invention.

FIG. 8 is a plan view illustrating a third diode with a resistor for use in the RF amplifier according to the fifth embodiment of the present invention.

FIG. 9 is a plan view illustrating part of the RF amplifier of the fifth embodiment of the present invention, in which the third diode with the resistor is used.

FIG. 10 is a cross-sectional view schematically illustrating a cross-sectional configuration of a set of a transistor, diode, and ballast resistor in the RF amplifier according to the fifth embodiment of the present invention.

FIG. 11 is a circuit diagram illustrating an exemplary conventional RF amplifier.

FIG. 12 is a cross-sectional view illustrating an exemplary conventional diode.

FIG. 13 is a plan view illustrating another exemplary conventional diode.

FIG. 14 is a plan view illustrating another exemplary conventional diode.

FIGS. 15A and 15B are circuit diagrams illustrating exemplary conventional RF amplifiers.

### DETAILED DESCRIPTION OF THE INVENTION

### FIRST EMBODIMENT

A first embodiment of the present invention will be described with reference to the accompanying drawings.

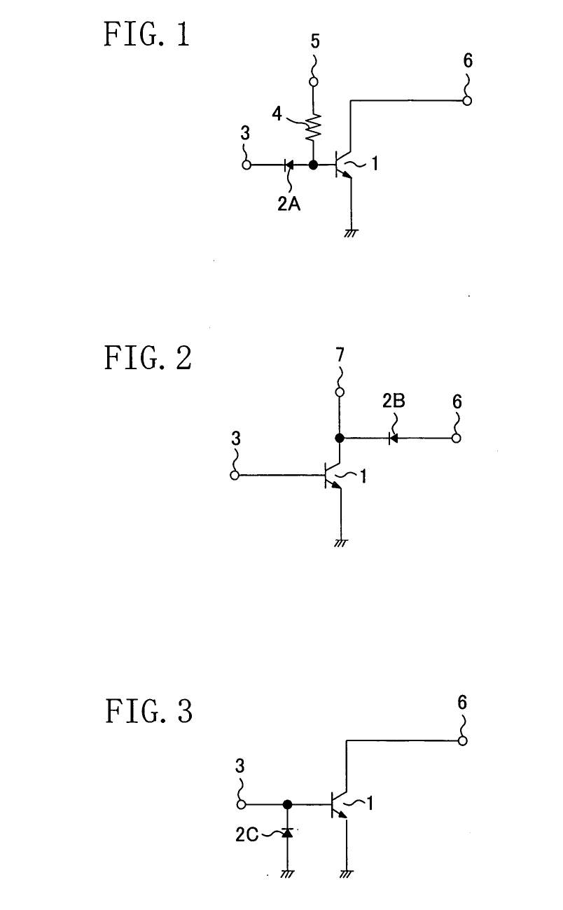

FIG. 1 illustrates an exemplary circuit of an RF amplifier according to the first embodiment of the present invention. As shown in FIG. 1, the RF amplifier of the first embodiment has a single stage structure in which a transistor 1, an NPN bipolar transistor, is included.

Between the base terminal of the transistor 1 and an input terminal 3, to which an RF signal is input, a diode 2A for the stabilization of the transistor 1 is connected. In this embodiment, the cathode of the diode 2A is connected to the input terminal 3 and the anode thereof is connected to the base terminal, but the connection in the opposite polarity relation, in which the cathode is connected to the base terminal and the anode is connected to the input terminal 3, may be employed.

One of the terminals of a resistor 4 is connected between the diode 2A and the transistor 1, while the other terminal of the resistor 4 is connected to a bias supply terminal 5. From the bias supply terminal 5, a DC voltage for applying an appropriate DC bias to the base terminal of the transistor 1 is applied. The collector terminal of the transistor 1 is connected to an output terminal 6.

As described above, in the first embodiment, the diode 2A, instead of a stabilizing resistor, is inserted in series between the base terminal of the transistor 1 and the input terminal 3, thereby the stabilization of the transistor 1.

In cases where the transistor 1 has a multi-stage amplifier instead of the single stage amplifier, if the amplitude of an input RF signal is sufficiently small, the voltage which makes the diode 2A turn on between the anode and cathode of the diode 2A is never generated, it is possible to cut off the DC current and pass only the RF signal, such that the RF amplifier can be reduced in size.

More specifically, it is possible to stabilize the transistor 1 by using the intrinsic series resistance of the diode 2A, and the PN junction capacitance in the diode 2A permits the desired RF signal to pass. Even if the diode 2A has the same area as the conventional MIM capacitor, the PN junction capacitance value in the diode 2A is about ten times as that of the MIM capacitor. Therefore, the area of the diode 2A can be made smaller than that of the MIM capacitor, which enables the size of the RF amplifier to be reduced.

### SECOND EMBODIMENT

Hereinafter, a second embodiment of the present invention will be described with reference to the accompanying drawings.

FIG. 2 illustrates an exemplary circuit of an RF amplifier according to the second embodiment of the present invention. In FIG. 2, the same members as those shown in FIG. 1 are identified by the same reference numerals and the descriptions thereof will be thus omitted herein.

As shown in FIG. 2, in the RF amplifier according to the second embodiment, a diode 2B for the stabilization of a transistor 1 is connected between the collector terminal of the transistor 1 and an output terminal 6, from which an RF signal amplified by the transistor 1 is output. In this embodiment, the cathode of the diode 2B is connected to the collector terminal and the anode thereof is connected to the output terminal 6, but the connection in the opposite polarity relation, in which the cathode is connected to the output terminal 6 and the anode is connected to the collector terminal, may be employed.

A bias supply terminal 7 for applying a DC bias is connected to the collector terminal of the transistor 1.

As described above, in the second embodiment, the diode 2B, instead of a stabilizing resistor, is inserted in series between the collector terminal of the transistor 1 and the output terminal 6, thereby stabilizing operation of the transistor 1.

In cases where the transistor 1 has a multi-stage amplifier instead of the single stage amplifier, if the amplitude of an output RF signal from the transistor 1 is sufficiently small, the voltage which makes the diode 2B turn on between the anode and cathode of the diode 2B is never generated, it is possible to cut off the DC current and pass only the RF signal, such that the RF amplifier can be reduced in size.

### THIRD EMBODIMENT

Hereinafter, a third embodiment of the present invention will be described with reference to the accompanying drawings.

FIG. 3 illustrates an exemplary circuit of an RF amplifier according to the third embodiment of the present invention. In FIG. 3, the same members as those shown in FIG. 1 are identified by the same reference numerals and the descriptions thereof will be thus omitted herein.

As shown in FIG. 3, in the RF amplifier according to the third embodiment, a diode 2C for the stabilization of a transistor 1 is connected between the base terminal of the transistor 1 and an input terminal 3 in parallel with the transistor 1.

In the third embodiment, a positive voltage is applied to the base terminal of the transistor 1. Therefore, in this embodiment, the cathode of the diode 2C is connected to the base terminal of the transistor 1 and the anode thereof is connected to the ground in order not to make the diode 2C turn on and continue to supply the appropriate DC bias current to the base terminal of the transistor 1.

As described above, in the third embodiment, the diode 2C, instead of a stabilizing resistor, is inserted in parallel between the input terminal 3 and the base terminal of the transistor 1, whereby the operation state of the transistor 1 is stabilized.

Since the diode 2C is connected in parallel with the transistor 1, the PN junction capacitance in the diode 2C allows a sufficient capacitance value to be obtained, even if the area of the diode itself is small. As a result, it is possible to realize a downsized RF amplifier capable of stably operating over a wide frequency band.

In addition, when the voltage applied across the anode and cathode of the diode 2C exceeds the on-state voltage or the breakdown voltage of the diode 2C, the diode 2C turns on and is bypassed to ground. The diode 2C thus also functions as a protection device for the transistor 1.

### FOURTH EMBODIMENT

Hereinafter, a fourth embodiment of the present invention will be described with reference to the accompanying drawings.

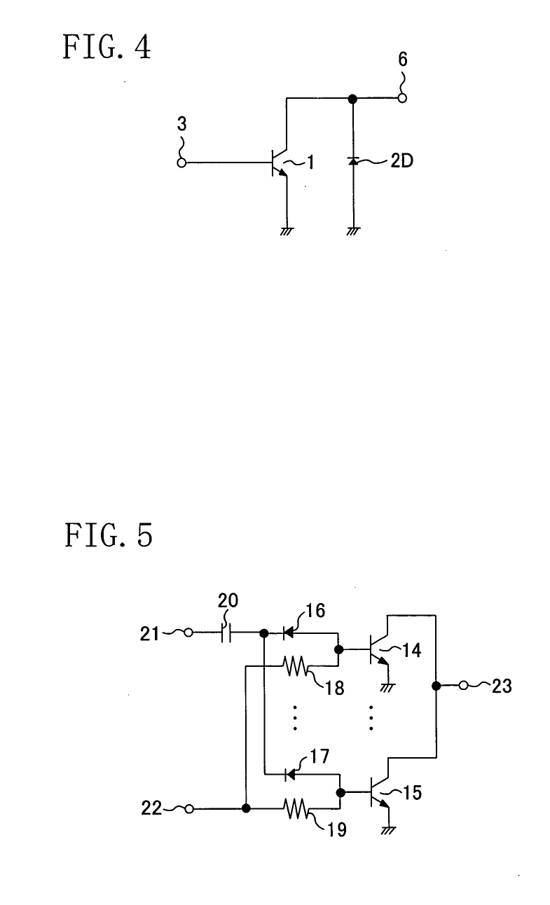

FIG. 4 illustrates an exemplary circuit of an RF amplifier according to the fourth embodiment of the present invention. In FIG. 4, the same members as those shown in FIG. 1 are identified by the same reference numerals and the descriptions thereof will be thus omitted herein.

As shown in FIG. 4, in the RF amplifier according to the fourth embodiment, a diode 2D for the stabilization of a transistor 1 is connected between the collector terminal of the transistor 1 and an output terminal 6 in parallel with the transistor 1.

In the fourth embodiment, a positive voltage is applied to the collector terminal of the transistor 1. In this embodiment, therefore, the cathode of the diode 2D is connected to the collector terminal of the transistor 1 and the anode thereof is connected to the ground in order not to make the diode 2D turn on and continue to supply the appropriate DC bias current to the collector terminal of the transistor 1.

As described above, in the fourth embodiment, the diode 2D, instead of a stabilizing resistor, is inserted in parallel between the collector terminal of the transistor 1 and the output terminal 6, whereby the operation state of the transistor 1 is stabilized.

Since the diode 2D is connected in parallel with the transistor 1, the PN junction capacitance in the diode 2D allows a sufficient capacitance value to be obtained, even if the area of the diode itself is small. As a result, it is possible to realize a downsized RF amplifier capable of stably operating over a wide frequency band.

In addition, when the voltage applied across the anode and cathode of the diode 2D exceeds the on-state voltage or the breakdown voltage of the diode 2D, the diode 2D turns on and is bypassing to ground. The diode 2D thus also functions as a protection device for the transistor 1.

### FIFTH EMBODIMENT

Hereinafter, a fifth embodiment of the present invention will be described with reference to the accompanying drawings.

FIG. 5 illustrates an exemplary circuit of an RF amplifier according to the fifth embodiment of the present invention. As shown in FIG. 5, the RF amplifier according to the fifth embodiment has a single stage structure which includes n parallel-connected transistors 14 to 15 (n≧2), which are NPN bipolar transistors.

Of the n transistors, the transistor 14 is the first and the transistor 15 is the n-th. A diode 16 for the stabilization of the transistor 14 and a ballast resistor 18 for stably applying a DC bias to the transistor 14 are connected in parallel with the base terminal of the first transistor 14. Likewise, a diode 17 for the stabilization of the transistor 15 and a ballast resistor 19 for stably applying a DC bias to the transistor 15 are connected with the base terminal of the n-th transistor 15. The collector terminals of the respective transistors 14 and 15 are connected each other and then connected to an output terminal 23. Although not shown, the second to n−1th transistors of the n transistors have the same structure.

The anodes of the respective diodes 16 and 17 for the stabilization of the transistors 14 and 15 are connected to the base terminals of the respective transistors 14 and 15, while the cathodes thereof are connected each other and then connected to an input terminal 21. Between the input terminal 21, to which an RF signal is input, and the cathodes of the diodes 16 and 17, a capacitor 20 having a capacitance of 10 pF, for example, is connected to cut off the DC current contained in the input signal. The diodes 16 and 17 may be connected in the opposite polarity relation, in which their anodes are connected to the input terminal 21 and their cathodes are connected to the bases of the respective transistors 14 and 15.

The terminals of the respective ballast resistors 18 and 19 away from the base terminals are connected each other and then connected to a bias input terminal 22. From the bias input terminal 22, a DC voltage for applying an appropriate DC bias to the base terminals of the respective transistors 14 and 15 is applied.

In this embodiment, for example, heterojunction bipolar transistors (HBT) are used as the NPN bipolar transistors, and the 20 HBTs are connected in parallel. Each of the ballast resistors 18 and 19 preferably has a resistance value of from 100Ω to 500Ω and in this embodiment they have a resistance value of 200Ω. The plane area of each of the diodes 16 and 17 is about 0.001 mm².

As described above, in the fifth embodiment, in cases where the transistors 14 and 15 are connected in parallel with each other for operation, even if a failure occurs in a neighboring transistor for some reason, the DC current from that failed transistor is cut off and does not flow into the normally operating transistors, which permits the normally operating transistors to continue their amplification operation. And even if the base terminal of the failed transistor is short-circuited to the emitter terminal, all of the bias current does not flow into the ground, because the resistance values of the respective ballast resistors 18 and 19 are sufficiently high. Consequently, it is possible to minimize variations in the current flowing into the base terminals of the normally functioning transistors, so that no failures occur in their amplification operation. This prevents abnormal operation or operation shutdown in the RF amplifier caused by the failure occurring in one of the n transistors.

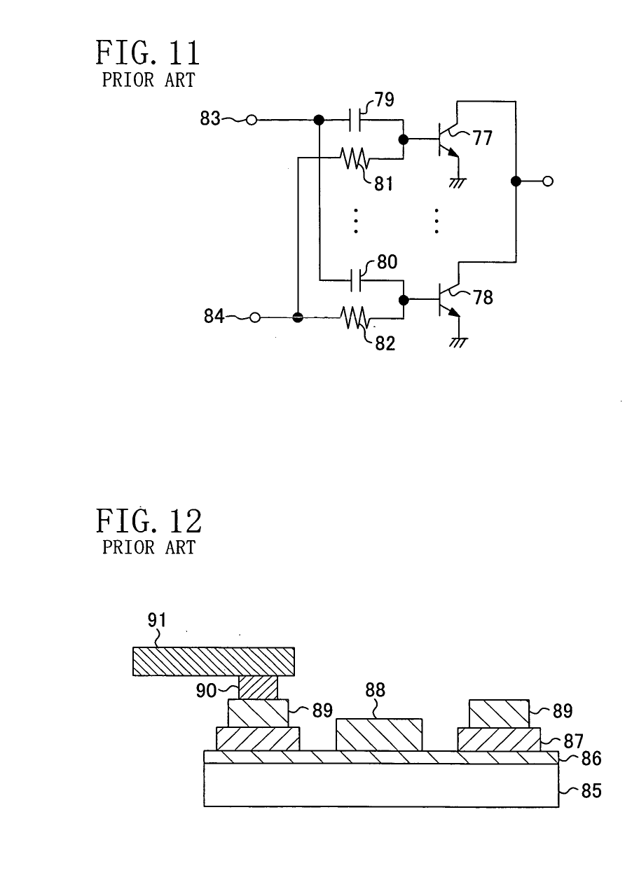

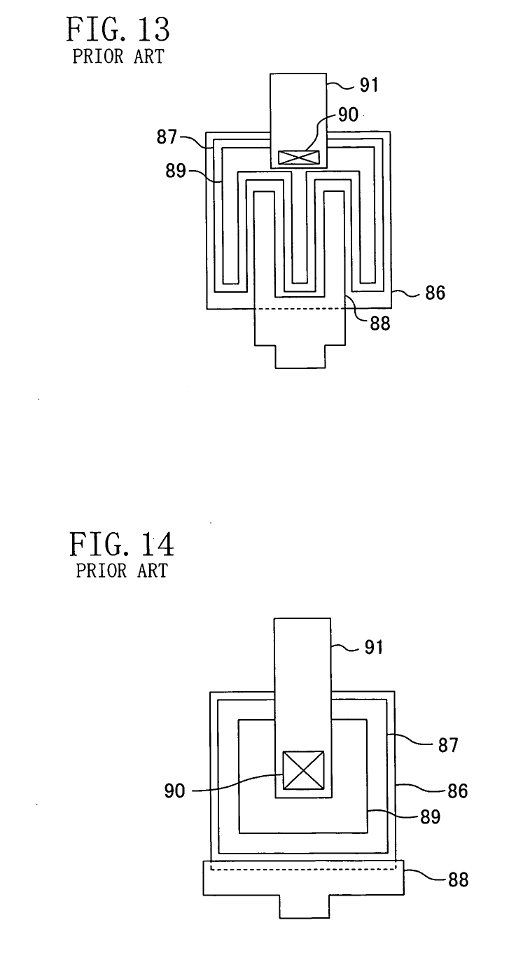

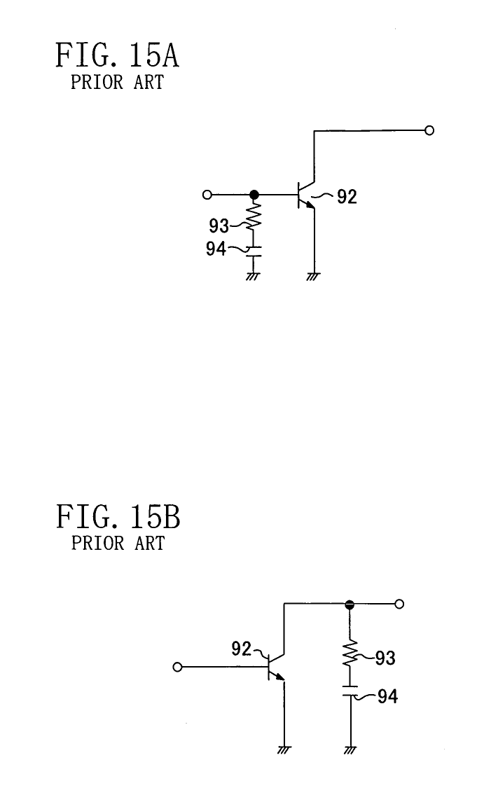

Also, in cases where a potential difference occurring at the input terminal 21 is small enough not to exceed the sum of the on-state voltage and breakdown voltage of the diodes 16 and 17, the flow of DC current across adjacent transistors is blocked. In the conventional example shown in FIG. 11, the capacitor 79 and the like perform such DC current blockage. In the fifth embodiment, the diodes 16 and 17 are used. In cases where there is no such potential difference between adjacent transistors that makes the diode 16 and the like turn on, the diode 16 and the like can sufficiently block the DC current without using any capacitors.

This enables the ballast resistors 18 and 19 provided for the respective transistors 14 and 15 to function effectively. These effectively functioning ballast resistors 18 and 19 prevent concentration of current in one of the transistors caused by a failure occurring in that one transistor, whereby a stable and highly reliable RF amplifier can be realized.

(Exemplary Structure of a First Diode)

Hereinafter, an exemplary specific structure of the diodes 2A to 2D described in the first to fourth embodiments and the diodes 16 and 17 described in the fifth embodiment will be described with reference to the accompanying drawings.

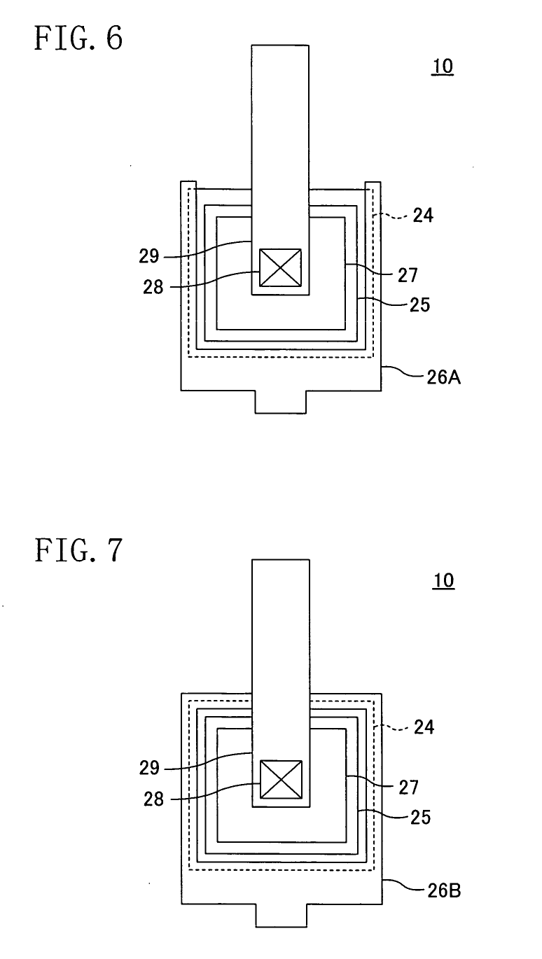

FIG. 6 illustrates the plan configuration of a first diode for use in an RF amplifier according to the present invention. As shown in FIG. 6, the first diode includes a p-type doped layer 24 and an n-type doped layer 25. The p-type doped layer 24, which has the shape of a rectangle when viewed from above, is formed in the upper portion of a GaAs semi-insulating substrate 10 and has a thickness of about 50 nm to about 200 nm and a concentration of about 1×10¹⁹ cm⁻³. The n-type doped layer 25, having the shape of a rectangle when viewed from above, is formed on the p-type doped layer 24 except for the peripheral portion thereof and has a concentration of about 1×10¹⁸ cm⁻³.

On the p-type doped layer 24, a first metal interconnect (anode) 26A is formed so as to be electrically connected with three of the four side portions of the p-type doped layer 24 that is rectangular in plan shape. The n-type doped layer 25 is connected to a second metal interconnect (cathode) 27 formed thereon. The second metal interconnect 27 is connected to a third metal interconnect 29 by a through hole 28 formed on the second metal interconnect 27. In this embodiment, the first and second metal interconnects 26A and 27 are formed in the same interconnect layer. The third metal interconnect 29 formed in the layer above the first metal interconnect 26A is insulated from the first metal interconnect 26A.

The feature of the first diode is that the p-type doped layer 24 is connected at its three sides to the first metal interconnect 26A, which reduces the contact resistance (series resistance) of the first metal interconnect 26A with respect to the p-type doped layer 24 having a high sheet resistance as described above.

(Exemplary Structure of a Second Diode)

Next, an exemplary structure of a second diode will be described. FIG. 7 illustrates the plan configuration of the second diode for use in an RF amplifier according to the present invention. In FIG. 7, the same members as those shown in FIG. 6 are identified by the same reference numerals and the descriptions thereof will be thus omitted herein.

As shown in FIG. 7, in the second diode, a p-type doped layer 24, which is rectangular in shape when viewed from above, is connected at its four sides, i.e., at its entire perimeter, to a first metal interconnect 26B. This allows still further reduction in the contact resistance (series resistance) with respect to the p-type doped layer 24.

(Exemplary Structure of a Third Diode)

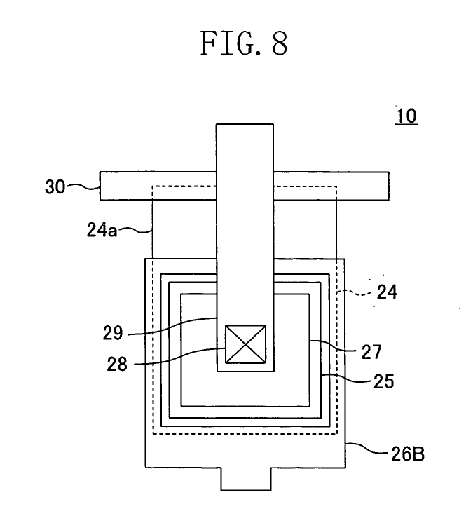

Next, an exemplary structure of a third diode will be described. FIG. 8 illustrates the plan configuration of the third diode with a resistor for use in an RF amplifier according to the present invention. In FIG. 8, the same members as those shown in FIG. 6 are identified by the same reference numerals and the descriptions thereof will be thus omitted herein. The third diode with the resistor is applicable to the diodes 2A to 2D of the first to fourth embodiments.

As shown in FIG. 8, in the third diode as in the second diode, a p-type doped layer 24, which is rectangular in shape when viewed from above, is connected at its four sides, i.e., at its entire perimeter, to a first metal interconnect 26B.

Furthermore, the third diode of this exemplary structure includes an extended portion 24a, obtained by extending one side of the p-type doped layer 24 beyond the perimeter of the first metal interconnect 26B so that the p-type doped layer 24 has an elongated rectangular shape when viewed from above. On the extended portion 24a, a fourth metal interconnect 30 is formed so as to be electrically connected with one side of the extended portion 24a. The p-type doped layer, having a thickness of from about 50 nm to about 200 nm, is so thin that the sheet resistance thereof is high, allowing the extended portion 24a of the p-type doped layer 24 to function as a resistor.

The plan shape of the p-type doped layer 24 is not limited to a rectangle (a quadrilateral), but may be a triangle or a polygon with five or more vertices. In those cases, the connection between the p-type doped layer 24 and the first metal interconnect 26B or the like is preferably made in such a manner that at least two sides of the polygon are in contact with the first metal interconnect 26B or the like. Alternatively, the plan shape f the p-type doped layer 24 may be circular or elliptical. In those cases, the first metal interconnect 26B or the like is preferably connected to the p-type doped layer 24 in such a manner that first metal interconnect 26B is in contact with more than 75% of the perimeter of the p-type doped layer 24.

Hereinafter, an exemplary structure of an RF amplifier according to the fifth embodiment, in which the third diode is used, will be described with reference to the accompanying drawings.

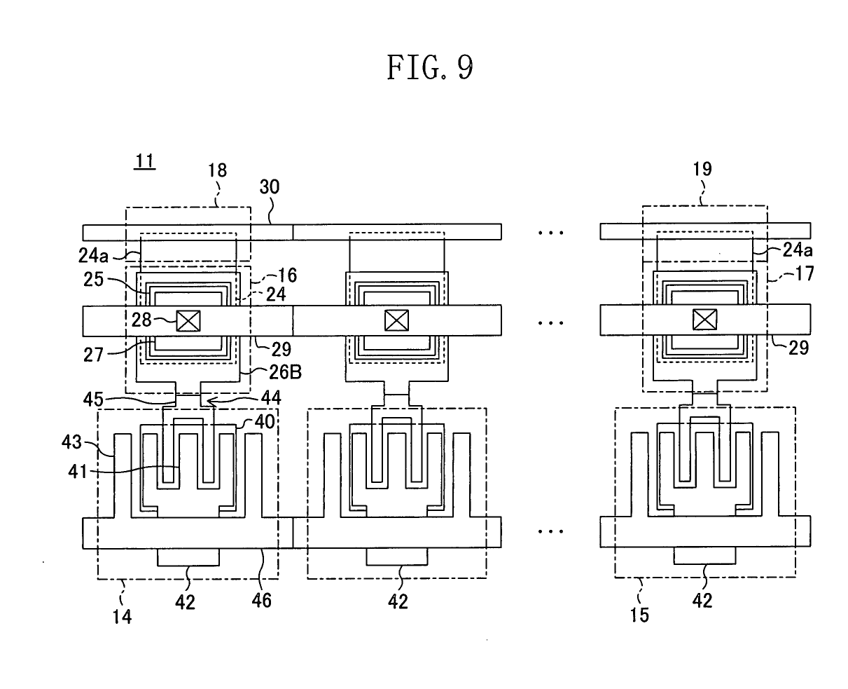

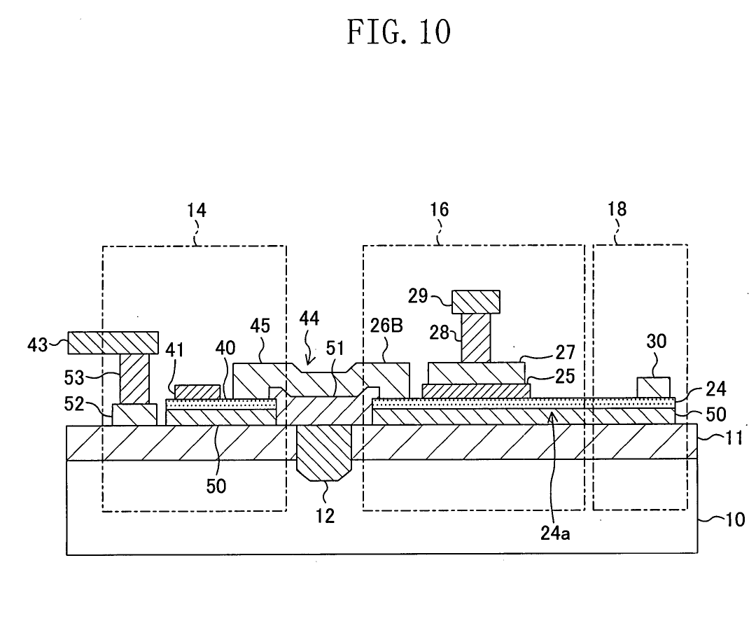

FIG. 9 shows the plan configuration of part of the RF amplifier according to the fifth embodiment of the present invention, in which the third diode is used, while FIG. 10 schematically shows a cross-sectional configuration thereof. In FIGS. 9 and 10, the same members as those shown in FIGS. 5 and 8 are identified by the same reference numerals and the descriptions thereof will be thus omitted herein.

As shown in FIG. 9, transistors 14, 15 and the like, which are heterojunction bipolar transistors (HBT), are connected in parallel.

As shown in FIG. 10, a first n-type heavily doped layer 11 having a thickness of 300 nm and a dopant concentration of 1×10¹⁸ cm⁻³ is formed on the entire surface of a semi-insulating substrate 10.

As shown in FIGS. 9 and 10, the transistor 14 includes a second n-type doped layer 50, a p-type doped layer 40, and a third n-type doped layer 41. The second n-type doped layer 50 is selectively formed on the first n-type doped layer 11, has a thickness of 1000 nm, and serves as a collector. The p-type doped layer 40, which is rectangular in shape when viewed from above, is selectively formed on the second n-type doped layer 50, has a thickness of 100 nm, and serves as a base. The third n-type doped layer 41, which has the shape of a comb when viewed from above, is selectively formed on the p-type doped layer 40, has a thickness of 300 nm, and serves as an emitter. The third n-type doped layer 41 has an extended portion 42. The part of the first n-type doped layer 11 which is included in the transistor 14 functions as a sub-collector layer.

In the first n-type doped layer 11, a device isolation region 12 made of silicon nitride is formed between the transistor 14 and a diode 16.

In the transistor 14, a seventh metal interconnect 52 is formed in a region on the first n-type doped layer 11 alongside the second n-type doped layer 50, and a collector terminal 43 is formed with a through hole 53 existing thereunder which is connected with the seventh metal interconnect 52.

The diode 16 includes a p-type doped layer 24 and an n-type doped layer 25. The p-type doped layer 24 is selectively formed on a second n-type doped layer 50 on the first n-type doped layer 11, has a thickness of 100 nm, and serves as the anode. The n-type doped layer 25 is selectively formed on the p-type doped layer 24, has a thickness of 300 nm, and serves as the cathode.

The p-type doped layer 40 serving as the base of the transistor 14 and the p-type doped layer 24 serving as the anode of the diode 16 are connected with each other by a fifth metal interconnect 44. The terminal of the fifth metal interconnect 44 close to the p-type doped layer 40 is a base terminal 45 having the shape of a comb when viewed from above, while the terminal thereof close to the p-type doped layer 24 is a first metal interconnect 26B.

Also, a dielectric layer 51 made of silicon nitride is formed in a region on the device isolation region 12 between the second n-type doped layers 50 under the fifth metal interconnect 44.

A second metal interconnect 27 is connected with a third metal interconnect 29 by a through hole 28 formed on the second metal interconnect 27, and an RF signal is input to the second metal interconnect 27 from the third metal interconnect 29.

A ballast resistor 18 is electrically connected with a fourth metal interconnect 30 by the extended portion 24a of the p-type doped layer 24 in the diode 16. The extended portion 24a functions as a resistor.

Adjacent fourth metal interconnects 30 are connected with each other, and a DC bias is applied to the base terminals 45 of the respective transistors 14 and 15 by way of the metal interconnects 30.

Adjacent sixth metal interconnects 46 are connected with each other, and the sixth metal interconnects 46 are connected to the output terminal of the RF amplifier.

The extended portions 42 of the third n-type doped layers 41, which are the emitters of the respective transistors 14 and 15, are each connected to the ground.

The fifth and seventh metal interconnects 44 and 52 are formed in the same interconnect layer and are also used to connect adjacent devices. The third and sixth metal interconnects 29 and 46 are formed in the same interconnect layer. The interconnect layer in which the fifth metal interconnects 44 and the like are formed is different from the interconnect layer in which the third metal interconnects 29 and the like are formed.

As described above, in the RF amplifier according to the present invention, the series resistance in the diode provided for each transistor functions as a stabilizing resistor. This enables the RF amplifier to operate stably without causing abnormal oscillation of the amplifier, burning of power supply paths, and variation in operating current. Therefore, abnormal oscillation and thermal runaway of the transistors are prevented such that their operation is kept stable. In addition, the RF amplifier of the present invention, which achieves the reduction in size by the use of diodes, is applicable, for example, to an RF amplifier for use in wireless communication systems used as mobile terminals such as cellular phones or as fixed terminals in base stations for amplification of RF communication signals used by the wireless communication system.

What is claimed is:

1. An RF amplifier comprising:
a transistor for an RF signal amplification; and
a diode which is connected at one of two terminals thereof to an input terminal of the transistor and receives the RF signal at the other terminal.

2. The RF amplifier of claim 1, wherein in the diode, a first doped layer of a first conductivity type and a second doped layer of a second conductivity type formed on the first doped layer form a junction;
a first electrode is formed on the first doped layer and a second electrode is formed on the second doped layer; and
the first electrode is not in contact with the second doped layer, and when the first doped layer has the shape of a polygon with n vertices when viewed from above (n≧3), the first electrode is connected with the first doped layer in such a manner that the first electrode is in contact with at least two sides of the polygon, and when the first doped layer has the shape of a circle or an ellipse when viewed from above, the first electrode is connected with the first doped layer in such a manner that the first electrode is in contact with more than 75% of the perimeter of the circle or the ellipse.

3. The RF amplifier of claim 2, wherein the first electrode is connected to the input terminal or an output terminal of the transistor; and
a third electrode for applying a DC bias to the transistor is formed on the first doped layer.

4. An RF amplifier comprising:
a transistor for an RF signal amplification; and
a diode which is connected at one of two terminals thereof to an output terminal of the transistor and outputs from the other terminal an amplified RF signal obtained by amplifying the RF signal.

5. The RF amplifier of claim 4, wherein in the diode, a first doped layer of a first conductivity type and a second doped layer of a second conductivity type formed on the first doped layer form a junction;
a first electrode is formed on the first doped layer and a second electrode is formed on the second doped layer; and
the first electrode is not in contact with the second doped layer, and when the first doped layer has the shape of a polygon with n vertices when viewed from above (n≧3), the first electrode is connected with the first doped layer in such a manner that the first electrode is in contact with at least two sides of the polygon, and when the first doped layer has the shape of a circle or an ellipse when viewed from above, the first electrode is connected with the first doped layer in such a manner that the first electrode is in contact with more than 75% of the perimeter of the circle or the ellipse.

6. The RF amplifier of claim 5, wherein the first electrode is connected to an input terminal or the output terminal of the transistor; and
a third electrode for applying a DC bias to the transistor is formed on the first doped layer.

7. An RF amplifier comprising:
a transistor for an RF signal amplification; and
a diode which is connected at one of two terminals thereof to an input terminal of the transistor and is grounded at the other terminal.

8. The RF amplifier of claim 7, wherein in the diode, a first doped layer of a first conductivity type and a second doped layer of a second conductivity type formed on the first doped layer form a junction;
a first electrode is formed on the first doped layer and a second electrode is formed on the second doped layer; and
the first electrode is not in contact with the second doped layer, and when the first doped layer has the shape of a polygon with n vertices when viewed from above (n≧3), the first electrode is connected with the first doped layer in such a manner that the first electrode is in contact with at least two sides of the polygon, and when the first doped layer has the shape of a circle or an ellipse when viewed from above, the first electrode is connected with the first doped layer in such a manner that the first electrode is in contact with more than 75% of the perimeter of the circle or the ellipse.

9. The RF amplifier of claim 8, wherein the first electrode is connected to the input terminal or an output terminal of the transistor; and
a third electrode for applying a DC bias to the transistor is formed on the first doped layer.

10. An RF amplifier comprising:
a transistor for an RF signal amplification; and
a diode which is connected at one of two terminals thereof to an output terminal of the transistor and is grounded at the other terminal.

11. The RF amplifier of claim 10, wherein in the diode, a first doped layer of a first conductivity type and a second doped layer of a second conductivity type formed on the first doped layer form a junction;
a first electrode is formed on the first doped layer and a second electrode is formed on the second doped layer; and
the first electrode is not in contact with the second doped layer, and when the first doped layer has the shape of a polygon with n vertices when viewed from above (n≧3), the first electrode is connected with the first doped layer in such a manner that the first electrode is in contact with at least two sides of the polygon, and when the first doped layer has the shape of a circle or an ellipse when viewed from above, the first electrode is connected with the first doped layer in such a manner that the first electrode is in contact with more than 75% of the perimeter of the circle or the ellipse.

12. The RF amplifier of claim 11, wherein the first electrode is connected to an input terminal or the output terminal of the transistor; and
a third electrode for applying a DC bias to the transistor is formed on the first doped layer.

13. An RF amplifier comprising:
a plurality of transistors, which are connected in parallel with each other and each of which amplifies an RF signal;
a plurality of diodes, each of which is connected at one of two terminals thereof to an input terminal of an associated one of the transistors and receives the RF signal at the other terminal; and
a plurality of resistors, each of which is connected at one of two terminals thereof to the input terminal of an associated one of the transistors and receives a DC bias signal at the other terminal.

14. The RF amplifier of claim 13, wherein in each of the diodes,
a first doped layer of a first conductivity type and a second doped layer of a second conductivity type formed on the first doped layer form a junction,
a first electrode is formed on the first doped layer and a second electrode is formed on the second doped layer, and
the first electrode is not in contact with the second doped layer, and when the first doped layer has the shape of a polygon with n vertices when viewed from above (n≧3), the first electrode is connected with the first doped layer in such a manner that the first electrode is in contact with at least two sides of the polygon, and when the first doped layer has the shape of a circle or an ellipse when viewed from above, the first electrode is connected with the first doped layer in such a manner that the first electrode is in contact with more than 75% of the perimeter of the circle or the ellipse.

15. The RF amplifier of claim 14, wherein the first electrode is connected to the input terminal of an associated one of the transistors; and
a third electrode for applying a DC bias to the transistor is formed on the first doped layer.
